(19) United States
(12) Patent Application Publication
(10) Pub. No.: US 2018/0207525 A1
(43) Pub. Date: Jul. 26, 2018

(54) METHOD AND GAME MACHINE FOR PLAYING MULTI-HAND POKER

(71) Applicant: JTG Technology Group Ltd., Jerusalem (IL)

(72) Inventors: Yaakov Israel Amar, Modi'in (IL); Jonathan Melman, Ramot Bet (IL)

(21) Appl. No.: 15/677,688

(22) Filed: Aug. 15, 2017

(30) Foreign Application Priority Data
Jan. 22, 2017 (IL) 250229

(51) Int. Cl. A63F 13/335; A63F 13/35; A63F 13/77; A63F 13/95; A63F 1/00

(52) U.S. Cl. CPC A63F 13/335; A63F 13/35; A63F 13/77; A63F 13/95; A63F 2300/60; A63F 2001/005; A63F 2300/407; A63F 2300/5533; A63F 1/00

(57) ABSTRACT

A computer-implemented card game played between two computer devices in communication via a server, wherein the server randomly deals to each computer device a plurality of cards one at a time from a deck of cards comprising a 53-card deck, one of which has a designated value and can represent any suit during play to form multiple pairs of competing hands each having a predetermined number of cards wherein at least one of each player's hands is a semi-revealed hand some of whose cards are revealed and some hidden to an opponent. During dealing, the server places each successive card in one of the hands such that once placed the associated computer device cannot move the card to another hand and once a card is placed in a hand, the server cannot place a successive card in the same hand until all of the hands are equally populated.

### CROSS-REFERENCE TO RELATED APPLICATIONS

The present application claims the benefit of Israeli Application Ser. No. 250229, filed Jan. 22, 2017, which is incorporated by reference in its entirety herein for all purposes.

### TECHNICAL FIELD

This disclosure relates generally to games, and more particularly to a system and method for concurrently playing a plurality of poker games.

### BACKGROUND

Poker is an enormously popular game around the world. The present disclosure offers a new way to play poker with multiple hands against another player. The idea of multi-hand poker is known per se. For example, in U.S. Pat. No. 5,823,873 a player is dealt a hand of cards and elects which of the cards in that first hand to hold. The cards held in the first hand are then duplicated to other hands, the number of additional hands depending generally on the amount bet by the player. This forms a number of hands each containing the exact same cards. The non-held cards in the first hand are then replaced to form a new first hand, and cards are added to the additional hands to complete those hands. The poker rank of each hand is then determined.

In U.S. Patent Publication No. 2004/0219970 multiple poker hands are played as part of the same game. Each hand may be played according to a different set of poker rules and the outcome of each hand is determined by comparison to the set of rules selected for that hand.

U.S. Patent Publication No. 2015/0221185 discloses comprise a poker gaming system wherein a user can select a number of user hands and a number of dealer hands to play against. Cards are dealt to both the user and the dealer. The user may place an initial bet based on his hand(s) and the likelihood that his hand(s) are better than each of the dealer's hands. The player may also have the option to place side bets in which the user may receive bonuses based on his hand(s). After the user places his bets, the dealer's hands are revealed. The user's hand(s) are compared to each of the dealer's hands, and payouts are determined.

While conventional poker is played with a 52-card deck, variations of poker may use fewer cards. For example, U.S. Patent Publication No. 2013/0178267 discloses a variation of a video poker game that employs a stripped standard 52 card deck with certain cards removed. For example, one type of stripped deck is a standard 52 card deck with all 2's through 9's removed. This greatly reduces the number of possible combinations and provides the player with a huge advantage.

U.S. Pat. No. 7,036,822 discloses poker game based on an Aces and 8's legend pays a high multiple of the amount bet for the highest winning hand containing two pair of aces and 8's, and pays a lower multiple of the amount bet for the second highest winning hand containing two pair other than aces and 8's. A hand of less than a pair and neither an ace nor an 8 wins the amount bet, and all other hands lose.

U.S. Patent Publication No. 2009/0227311 discloses a gaming machine for playing a poker game employing cards including trump cards and a special card. The special card functions as a wild card with respect to a specific type trump card. The specific type trump card is a trump card constituting one portion of card types from all types of trump card. A special card included in the player's hand is regarded as a specific type trump card.

U.S. Patent Publication No. 2014/0243078 discloses a gaming system and method for online poker play wherein players are assigned individual gaming devices comprising electronic game boards. Players access their assigned gaming device via a gateway from a remote presentation device such as a player's computer.

U.S. Patent Publication No. 2012/0098197 discloses a method of conducting a wagering game using a deck of cards.

### SUMMARY

In one aspect there is provided a computer-readable medium storing program code, which when executed by a server in association with two computers, deals to participating players cards from a 53-card deck, one of which has a designated value but can assume any suit during play.

In another aspect, the disclosure provides a computer-implemented card game played between two computer devices in communication with each other via a server, wherein the server is configured to randomly deal to each of the computer devices a plurality of cards one at a time from a deck of cards comprising a 53-card deck, one of which has a designated value but can assume any suit during play to form multiple pairs of competing hands each having a predetermined number of cards wherein at least one of each player's hands is a semi-revealed hand that contains some revealed cards and some cards that are hidden to an opponent; determine a winning hand for each pair of competing hands; and determine a winner of said game as a player having a larger number of winning hands. During dealing, the server is configured to place each successive card from the deck in one of the hands such that once placed, the associated computer device cannot move the card to another hand and once a card is placed in a hand, the server cannot place a successive card in the same hand until all of the hands are equally populated.

In some embodiments, one of each player's hands is a hidden hand all of whose cards are hidden to the opponent, and during dealing, each successive card from the deck is placed in the hidden hand or in one of the semi-revealed hands. Each of the remaining hands for each player is a semi-revealed hand that contains some revealed cards and some cards that are hidden to the opponent.

### BRIEF DESCRIPTION OF THE DRAWINGS

In order to understand the disclosure and to see how it may be carried out in practice, embodiments will now be described, by way of non-limiting example only, with reference to the accompanying drawings, in which:

FIGS. 1-3 are pictorial representations showing a display screen of a computer-implemented embodiment of a poker game, according to embodiments described herein.

FIGS. 4-14 are pictorial representations showing competing hands useful for understanding the rules of the game, according to embodiments described herein.

FIGS. 15-17 are pictorial representations showing different end-states of completed matches, according to embodiments described herein.

FIG. 18 is a schematic representation of a computer-implemented system for allowing two players to play the game remotely, according to embodiments described herein.

### DETAILED DESCRIPTION OF EMBODIMENTS

Embodiments of the disclosure may be used in connection with live gaming table environments or in computer-implemented environments where a first player competes against an opponent. In a computer-implementation, the opponent can be another player typically located remotely from the first player or a virtual opponent such as the dealer. Single participant embodiments of the disclosure generally involve a single game “participant” with no other players associated with the game. The other hands that are not dealt to the game participant are therefore not dealt to an actual player, as there are no other actual players in the single participant embodiments. However, for purposes of this description, the remaining hands which are not dealt to the actual game participant may be described as being dealt to “virtual players” for purposes of facilitating an understanding of the operation of the disclosure. Therefore, while the game will be described with reference to two players, it is to be understood that one of the players may be virtual.

Regardless as to whether an opponent is an actual or a virtual player, each player is dealt multiple hands and at the end of the game, the participant's hands are compared to the remaining resulting hands of the opponent.

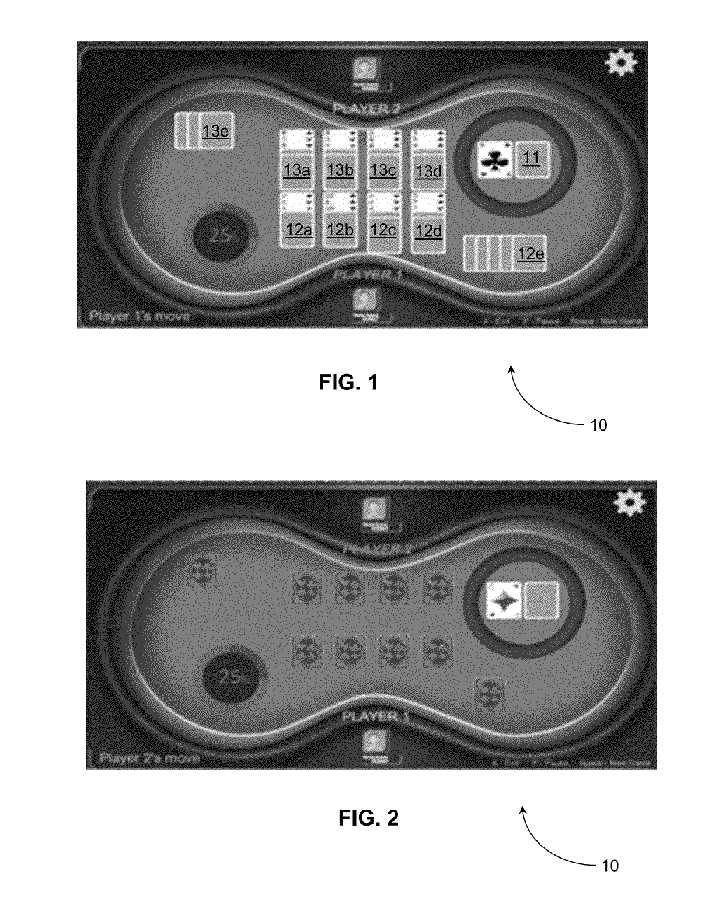

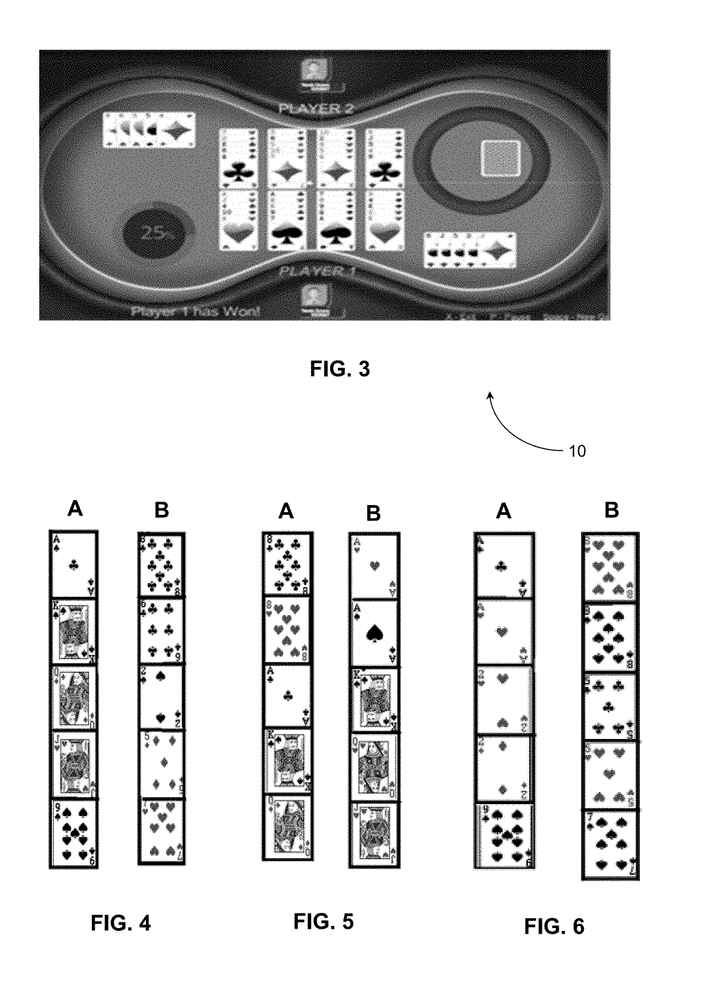

FIGS. 1-3 are pictorial representations showing a display screen of a computer-implemented embodiment of a poker game, according to embodiments described herein In particular, FIGS. 1-3 display a game table 10 in the form of a figure “8” rotated on its side in the form of “∞”. In a live version of the game two players, denoted Player 1 and Player 2, sit opposite each other in the narrow waist portions of the table. In a computer-implemented version of the game, the players are located remotely from each other and each sees the game display on his or her computer screen. It will be under-stood that in the context of the description and appended claims, the term “computer” is intended to refer to any device having a processor, display screen and communication port for allowing connection between two like devices, which can be computers, game stations, smartphones and so on. The dealer 11 is shown toward the top right of the table designated by an upturned Club and the deck face down. Each player is dealt multiple hands 12a-12e and 13a-13e, respectively according to rules that will shortly be described. The hands {12a, 13a}, {12b, 13b}, {12c, 13c}, {12d, 13d} and {12e, 13e} constitute multiple pairs of competing hands of which the four hands suffixed a, b, c and d in each pair are semi-revealed hands some of whose cards are face down to the opponent and others that are face up i.e. revealed. The fifth hand of each pair 12e, 13e, respectively is a “hidden” hand all of whose cards are hidden to the respective opponent. In a basic form of the game, hidden cards are hidden only to the opponent. In the computer-implemented version of the game, each player can reveal a hidden card to himself by pointing to the card whereby computer software is operative to reveal the card momentarily. In more advanced versions of the game, at least some hidden cards may remain hidden also to the owner, thus forcing him or to her to memorize these cards and increasing the challenge.

Upon commencing a game, the dealer deals cards to each player in turn. The rules of the game allow each player to place the cards thus received in a row thereby forming the first card of each of the four hands 12a-12d and 13a-13d or in the respective hidden hand 12e and 13e. At no time is a player obliged to place a card in the hidden hand, but when all of a player's semi-revealed hands are full i.e. 20 cards have been placed in the semi-revealed hands, the remaining complement are added to the hidden hand so that at the of dealing all five hands contain exactly five cards thereby utilizing in total 50 cards from the deck.

During dealing, a player may place a card that has just been dealt into the hidden hand although as noted above he does not have to. But at no time may he place more than two cards in the hidden hand while the current row is incomplete. In other words, as cards are dealt, each player is constrained to add each successive card dealt to him to a different one of the semi-revealed hands suffixed a-d or to the hidden hand subject to the above constraint. Furthermore, once a card has been placed in a semi-revealed hand, a player cannot place another card in the same hand until all the semi-revealed hands are equally populated and at no time may he move cards from one hand to another. As noted, a player may opt to hide some of the cards in the semi-revealed hands up to a designated maximum so that they are hidden from his opponent. In an embodiment of the disclosure reduced to practice, up to two cards in each hand may be thus hidden. These cards may be revealed to the owner or remain concealed also from the owner according to the degree of skill required. In the computer-implemented version of the game this may be set as an input parameter as may the maximum number of permissible hidden cards in each hand, the total number of hands and the number of cards in each hand.

Thus, while conventionally poker is played with five cards in each hand, this is not a requirement and fewer cards may be used. This will, of course, significantly change the odds. However, the remaining rules still apply and ensure that each hand is unique and cannot share cards as has been proposed in the prior art; and while a player has some flexibility in determining in which hand optimally to place a card during each round of dealing since initially a card can be placed in any of the five hands, as each round of dealing progresses, the flexibility is reduced because there are fewer remaining hands to populate and once a card has been placed in a given hand it is not permissible to add cards to the same hand until all the semi-revealed hands are equally populated.

We now add one final rule that makes this game even more interesting and challenging. Instead of utilizing a standard 52-card deck, some embodiments of the game use a 53-card deck, which of course changes the odds. The use of wild cards has been proposed in the art, but the disclosure uses an additional card that has a designated value but can assume any suit. For example, a card whose value is “8” may be added to the deck and may any assume any suit, clubs, spades, hearts and diamonds. This card is shown in FIGS. 8, 9, 13 and 14 as “Loaded 8” Furthermore, any other card in the deck having the same value of the additional card trumps any other card having a different value. So if a player has in his or her hand an 8 of any suit, this will trump even an ace of the same suit. However, the 8 or Loaded 8 does not act as a high card in hands such as straights, flushes and straight flushes. The 8 or Loaded 8 acts as the high card in all other hands.

In accordance with some embodiments, a winning hand is determined according to the following list in decreasing order of rank: a straight flush, a royal straight flush, kind-a-of-five, pair, two pairs, three of a kind, a straight, a flush, a full house, four of a kindhigh card.

Having described all the rules and variations of the game, FIGS. 4-14 show some different winning scenarios that will help to explain how the rules of the game are played out in practice, and how they provide a different challenge and experience from known variations of poker. Each of these figures shows two hands, each belonging to a different player “A” and “B”.

In FIG. 4, player B has the winning hand because it has an 8, which is the highest ranking card in the deck.

In FIG. 5, player A has the winning hand because a pair of 8's trumps a pair of aces.

In FIG. 6, player B has the winning hand because it contains a pair of 8's with a second pair (5's), which trumps player A's pair of aces and pair of 2's.

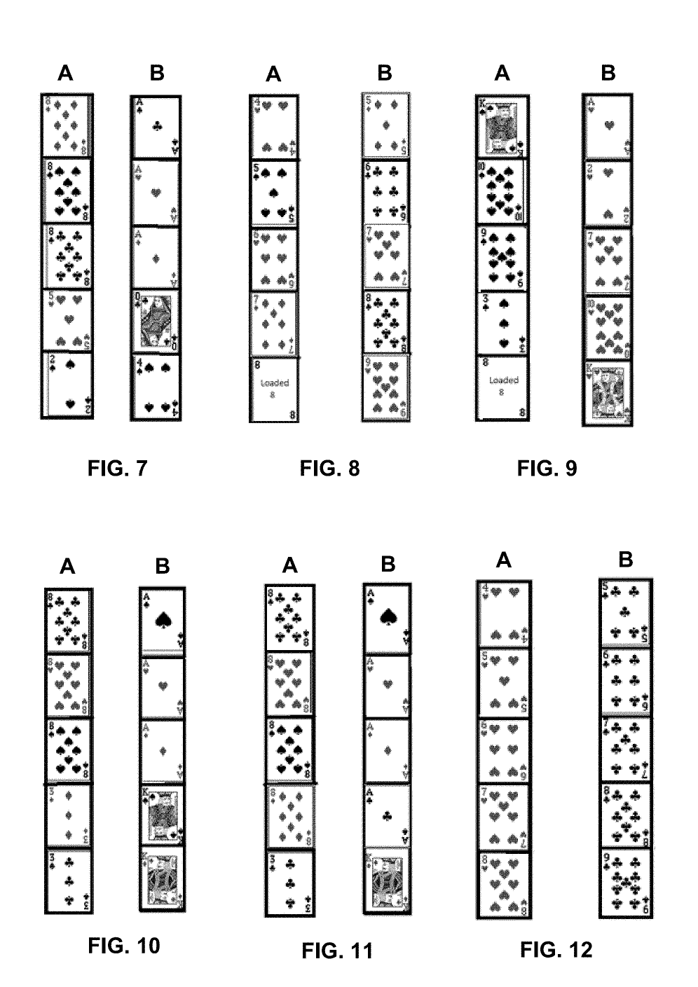

In FIG. 7, player A has the winning hand because it has three 8's, which represents the highest 3 of a kind in the game.

In FIG. 8, player B has the winning hand because it has a higher straight.

In FIG. 9, player A has four suited cards (spades). The Loaded 8 becomes a spade and makes a flush. But player B has the Ace high flush, making it the winning hand. This demonstrates that the Loaded 8 card does not become the card of highest rank, but only changes its suit to make a flush and will lose to a higher flush hand. As noted above, the 8 or Loaded 8 does not act as a high card in hands such as straights, flushes and straight flushes.

In FIG. 10, player A has a full house with 8's over 3's while player B has a full house with aces over kings. Player A has the winning hand because the 8 is the card of highest rank.

In FIG. 11, player A has four of a kind 8's, while player B has four of a kind Aces. Player A has the winning hand because the 8 is the card of highest rank.

In FIG. 12, player A has a straight flush to the 8 while player B has a straight flush to the 9. Therefore, player B has the winning hand because its straight flush is higher.

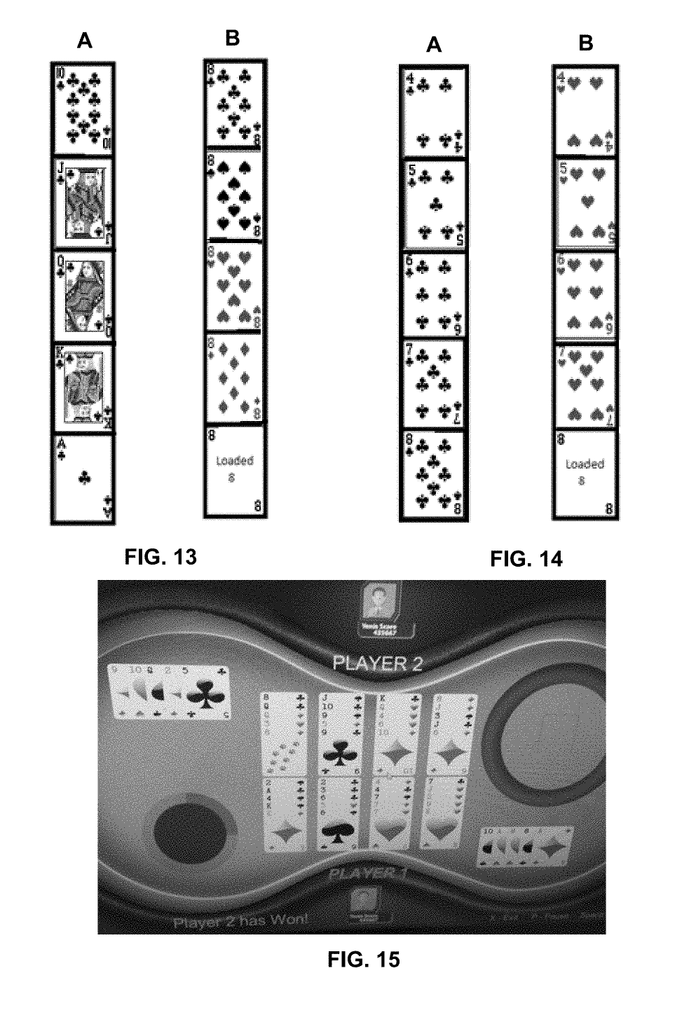

In FIG. 13, player A has a royal flush and player B has five 8's. Therefore, player B has the winning hand because five 8's is the hand of highest possible rank.

FIG. 14 shows a tie situation. Both players have a straight flush to the 8. The Loaded 8 card in B's hand plays as an 8 of hearts but the hands are identical since the Loaded 8 does not trump the plain 8 of clubs in A's hand.

FIG. 15 shows the end state of a game having the following hands: Hand #1: Player 2 has two pairs (Q's and 8's) and Player 1 has a pair of K's: Player 2 wins the hand (0-1); Hand #2: Player 2 has a pair of 9's and Player 1 has a pair of 6's: Player 2 wins the hand (0-2); Hand #3: Player 2 has a King high and Player 1 has a full house 7's over 4's: Player 1 wins the hand (1-2); Hand #4: Player 2 has a pair of J's and Player 1 has a K high: Player 2 wins the hand (1-3); Hidden Hand: Player 2 has a Q high and Player 1 has 2 pair (8's and A's) Player 1 wins the hand (2-3). Therefore player 2 wins the match by winning the majority of hands in the match. A player who wins all five hands in a match is rewarded with double the wager in that game.

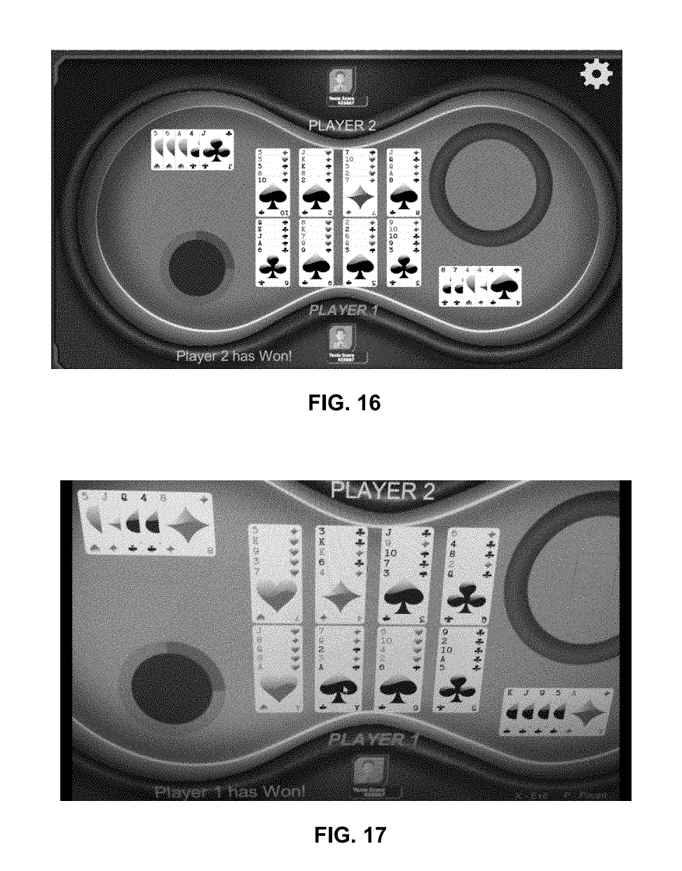

FIG. 16 shows the end of a game having the following hands: Hand #1: Player 2 has a pair of 3's and Player 1 has Ace high: Player 2 wins the hand (0-1); Hand #2: Player 2 has a pair of K's and Player 1 has a pair of 9's: Player 2 wins the hand (0-2); Hand #3: Player 2 has a pair of 7's and Player 1 has a pair of 2's: Player 2 wins the hand (0-3); Hand #4: Player 2 has a pair of Q's and Player 1 has 2 Pairs 9's and 10's: Player 1 wins the hand (1-3); Hidden Hand: Player 2 has Ace high and Player 1 has 3 of a kind 4's: Player 1 wins the hand (2-3). Therefore player 2 wins the match by defeating player 1 by a margin of 3-2.

FIG. 17 shows the end of a game having the following hands: Hand #1: Player 2 has a K high and Player 1 has a pair of 8's: Player 1 wins the hand (1-0); Hand #2: Player 2 has a pair of K and Player 1 has Ace high: Player 2 wins the hand (1-1); Hand #3: Player 2 has a Jack high and Player 1 has a pair of 6's: Player 1 wins the hand (2-1); Hand #4: Player 2 has a Q high and Player 1 has an Ace high Flush (clubs): Player 1 wins the hand (3-1); Hidden Hand: Player 2 has a Q high and Player 1 has an Ace high: Player 1 wins the hand (4-1). Therefore player 1 wins the match by winning majority of hand by a margin of 4-1.

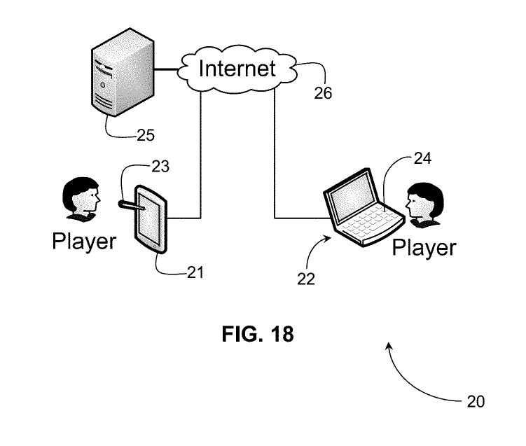

FIG. 18 shows schematically a computer-implemented system 20 for playing the game between two players each having a respective computer device 21, 22. The device 21 is shown as a tablet having a touch screen operated by a pointing device 23 that functions as a user-interface. The device 22 is shown as a computer having a keyboard 24 that functions as a user-interface. It will be appreciated that the device 21 may be a smartphone whose touch screen is operated by the user's finger. The devices 21 and 22 communicate with a server 25 over the Internet 26. The server 25 may be programmed to operate as a game manager for managing the game between the players and keeping tally of scores as well as controlling rewards in the form of tokens, bank or credit card payments and so on. Software in the server may also communicate with software in the devices 21, 22 for controlling how the game is played by adjusting the parameters as described above. Alternatively, the parameters may be entered by the players using the respective interfaces of devices 21, 22. In either case, when the game is played for wagers, the rewards may be computed by the server according to the selected parameters bearing in mind that they impact the odds and hence the likelihood of a given player having a winning hand.

The game also contemplates a method operated by a game provider where the server acts as the house and players buy tokens, which are used to make wagers as is well-known per se. In order to encourage prolonged activity, the house may offer a bonus to each player at regular intervals of time. For example, after each 4 hour session, a player's account may be credited with 100 tokens. In some embodiments, the server compiles for each player an experience bar which rises and falls based on their performance in the game. In one variation known as “Death Match” scores are doubled in the case where one player wins all five hands. Players are also able to play with different decks of cards. In some embodiments, a player may purchase with the games currency the ability to see at least one hidden card of his opponent thereby giving him an advantage in the game.

It will also be understood that the server and the computer devices according to the disclosure may be computers suitably programmed in either software or firmware. Likewise, the disclosure contemplates a computer program being readable by a computer for executing the method of the disclosure. The disclosure further contemplates a machine-readable memory tangibly embodying a program of instructions executable by the machine for executing the method of the disclosure.

What is claimed is:

1. A computer-readable medium storing program code, which when executed by a server in association with two computers, deals to participating players, each operating a respective one of the two computers, from a 53-card deck, wherein one particular card of the 53-card deck has a designated value and can represent any suit during play.

2. A computer-implemented card game system played between two computer devices in communication with each other via a server, a player operating a respective one of the two computer devices, wherein the server is configured to:
randomly deal to each of the computer devices a plurality of cards one at a time from a deck of cards comprising a 53-card deck, one of which has a designated value and can represent any suit during play to form multiple pairs of competing hands each having a predetermined number of cards, wherein at least one of each player's hands is a semi-revealed hand that contains some revealed cards and some cards that are hidden to an opponent;
determine a winning hand for each pair of competing hands; and
determine a winner of a game as a player having a larger number of winning hands;
wherein during dealing, the server is further configured to place each successive card from the 53-card deck in one of the hands where once placed the associated computer device cannot move the card to another hand and once a card is placed in a hand, the server cannot place a successive card in the same hand until all of the hands are equally populated.

3. The computer-implemented method of claim 2, wherein:
one of each player's hands is a hidden hand all of whose cards are hidden to an opposing player; and
during the dealing, each successive card from the 53-card deck is placed in the hidden hand or in one of the semi-revealed hands.

4. The computer-implemented card game according to claim 3, wherein each of the remaining hands for each player contains some revealed cards and some cards that are hidden to an opponent.

5. The computer-implemented method of claim 2, wherein during the dealing to each computer device, the respective computer device is configured to place more than one card from the 53-card deck in a hidden hand up to a specified maximum until all of the hands other than the hidden hand are equally populated and when dealing concludes all hands including the hidden hand are equally populated.

6. The computer-implemented method of claim 5, wherein any card in the 53-card deck comprises a designated value of an additional card trumps any other card having a different value.

7. The computer-implemented method of claim 5, wherein any card in the 53-card deck comprises a designated value of an additional card trumps any other card having a different value except in hands that are straights, flushes and straight flushes.

8. A computer-implemented method of playing a multi-line poker game of cards having multiple independent game hand lines between two players, wherein the multi-line poker game is played using a server communicating with two computer devices each operated by a respective one of the players, the method comprising:
the server randomly dealing to each of the computer devices a plurality of cards one at a time from a deck of fifty-three cards, one of which has a designated value and can represent any suit during play, to form multiple pairs of competing hands each having a predetermined number of cards wherein one of each player's hands is a hidden hand all of whose cards are hidden and each of the remaining hands for each player is a semi-revealed hand that contains some revealed cards and some cards that are hidden to an opponent;
during said dealing, each of the computer devices placing a successive card from the deck in the hidden hand or in one of the semi-revealed hands such that once placed the card cannot be moved to another hand and once a card is placed in a semi-revealed hand, a successive card cannot be placed in the same hand until all of the semi-revealed hands are equally populated;
the server determining a winning hand for each pair of competing hands; and
the server determining a winner of a game as a player having a larger number of winning hands.

9. The computer-implemented method of claim 8, wherein during the dealing to each computer device the respective computer device is configured to place more than one card from the 53-card deck in a hidden hand up to a specified maximum until all of the hands other than the hidden hand are equally populated and when dealing concludes all hands including the hidden hand are equally populated.

10. The computer-implemented method of claim 8, wherein any card in the 53-card deck comprises a designated value of an additional card trumps any other card having a different value.

11. The computer-implemented method of claim 8, wherein any card in the 53-card deck comprises a designated value of an additional card trumps any other card having a different value except in hands that are straights, flushes and straight flushes.

12. The computer-implemented method of claim 8, wherein the winning hand comprises any one of: of-five-a-kind, a royal straight flush, a straight flush, four of a kind, a full house, a flush, a straight, three of a kind, two pairs, a pair, and a high card.

13. The computer-implemented method of claim 8, wherein players purchase tokens from a game provider and use the tokens for wagering.

14. The computer-implemented method of claim 13, wherein the game provider credits a player's account according to cumulative elapsed time of play.

15. The computer-implemented method of claim 13, further comprising compiling for each player, by the server, an experience bar which rises and falls based on a player's performance in the multi-line poker game.

16. The computer-implemented method of claim 13, wherein scores are doubled when one player wins all hands.

17. The computer-implemented method of claim 13, wherein a player may use tokens to purchase an ability to see at least one hidden card of the opponent.

18. A non-transitory machine-readable storage medium storing computer program code which when executed on a host computer device causes the host computer device to perform steps comprising:
dealing, to two computer devices, a plurality of cards one at a time from a deck of fifty-three cards, one of which has a designated value and can represent any suit during play, to form multiple pairs of competing hands each having a predetermined number of cards, wherein each computer device is operated by a respective participating player, wherein one of each player's hands is a hidden hand all of whose cards are hidden and each of the remaining hands for each player is a semi-revealed hand that contains some revealed cards and some cards that are hidden to an opponent;
placing a successive card from the deck in the hidden hand or in one of the semi-revealed hands such that once placed the card cannot be moved to another hand and once a card is placed in a semi-revealed hand, a successive card cannot be placed in the same hand until all of the semi-revealed hands are equally populated;
determining a winning hand for each pair of competing hands; and
determining a winner of a game as a player having a larger number of winning hands.

19. The non-transitory machine-readable storage medium of claim 18, being responsive to at least one parameter entered by a user-interface of each computer device for setting at least one of the following:
number of hands in each game;
maximum number of cards in each hand;
maximum number of cards that can be placed in the hidden hand during each dealing round;
maximum number of cards that can be hidden in each semi-revealed hand; and
whether or not a player can reveal his own hidden cards in either or both of the semi-revealed hands and the hidden hands.

20. The non-transitory machine-readable storage medium of claim 18, further comprising compiling for each player an experience bar which rises and fall based on a player's performance.
